(19) United States
(12) Patent Application Publication
(10) Pub. No.: US 2018/0259801 A1
(43) Pub. Date: Sep. 13, 2018

(54) PROJECTION-TYPE DISPLAY DEVICE AND IMAGE DISPLAY METHOD

(71) Applicant: SONY CORPORATION, TOKYO (JP)

(72) Inventor: HIDEAKI KAWAURA, KANAGAWA (JP)

(21) Appl. No.: 15/556,571

(22) PCT Filed: Feb. 16, 2016
(86) PCT No.: PCT/JP2016/054427

§ 371 Date: Sep. 7, 2017

(30) Foreign Application Priority Data
Mar. 20, 2015 (JP) 2015-058003

(51) Int. Cl. G02F 1/133; G03B 21/14; G09G 3/34; G09G 3/36; H04N 5/74

(52) U.S. Cl. CPC G02F 1/13306; G03B 21/142; H04N 5/7416; G09G 3/36; G09G 3/3406

(57) ABSTRACT

The present invention is to provide a projection-type display device and an image display method with a configuration and structure with which problems such as an increase in a production cost, an increase in a size, and an increase in power consumption can be avoided, many processes are not necessary for assembling, and high assembling accuracy is not required. A projection-type display device of the present invention includes a light source (10), a light valve device (30), an illumination optical system (20) that makes pieces of light in different colors from the light source (10) respectively enter different regions (30R, 30G, and 30B) of the light valve device (30), and a projection optical system (40) that integrates images in different colors from the different regions (30R, 30G, and 30B) of the light valve device 30 into one image.

### TECHNICAL FIELD

The present disclosure relates to a projection-type display device and an image display method.

### BACKGROUND ART

For a projection-type display device (projector) of a high image quality type, brightness, abundance of gradation, and correspondence to a high frame rate are required as a function to express the high image quality. In a single-panel projector that can be manufactured with a low cost, it is difficult to realize these functions and there is a phenomenon called color breaking in principle. Thus, it is difficult to realize high image quality. Thus, as a high image quality-type projector, a three-plate projector that uses one each of a light valve device for red display, a light valve device for green display, and a light valve device for blue display is common (see, for example, Japanese Patent Application Laid-Open No. 2008-185873).

### CITATION LIST

### Patent Document

Patent Document 1: Japanese Patent Application Laid-Open No. 2008-185873

### SUMMARY OF THE INVENTION

### Problems to be Solved by the Invention

However, a three-panel projector requires three light valve devices, and three driving driver ICs to respectively drive the light valve devices. Thus, there are problems such as an increase in a production cost, an increase in a size (size of housing), and an increase in power consumption. Also, many processes and high accuracy are required for assembling of the three light valve devices.

Thus, the present disclosure is to provide a projection-type display device and an image display method with a configuration and structure with which problems such as an increase in a production cost, an increase in a size, and an increase in power consumption can be avoided, many processes are not necessary for assembling, and high assembling accuracy is not required.

### Solutions to Problems

In order to achieve the above object, a projection-type display device of the present disclosure includes:

a light source;

a light valve device;

an illumination optical system that makes pieces of light in different colors from the light source respectively enter different regions of the light valve device; and

a projection optical system that integrates images in different colors from the different regions of the light valve device into one image.

An image display method of the present disclosure to achieve the above object includes:

generating a plurality of color-separated image signals by performing color separation of an image signal;

forming images based on the color-separated image signals respectively in a plurality of regions of a light valve device; and

integrating the images formed in the plurality of regions of the light valve device into one image.

### Effects of the Invention

In a projection-type display device of the present disclosure, one light valve device is divided into a plurality of regions, images in different colors are respectively formed in the divided regions, and these images in different colors are integrated into one image. Also, in an image display method of the present disclosure, images based on color-separated image signals acquired by color separation of an image signal are respectively formed in a plurality of regions of one light valve device and these images are integrated into one image. Thus, it is possible to avoid problems such as an increase in a production cost, an increase in a size, and an increase in power consumption of a projection-type display device. Also, many processes are not necessary for assembling and high assembling accuracy is not required. Note that an effect described in the present specification is just an example and not the limitation. There may be an additional effect.

### BRIEF DESCRIPTION OF DRAWINGS

FIG. 1 is a conceptual diagram of a projection-type display device of a first embodiment.

FIGS. 2(A), (B), and (C) are respectively a schematic side view of a main part of the projection-type display device of the first embodiment, a schematic front view of a light valve device, and a schematic top view of the main part of the projection-type display device of the first embodiment.

FIG. 3 is a schematic perspective view of the main part of the projection-type display device of the first embodiment.

FIG. 4A and FIG. 4B are respectively conceptual diagrams of an image control circuit in the projection-type display device of the first embodiment and that in a conventional three-panel projection-type display device.

### MODE FOR CARRYING OUT THE INVENTION

In the following, the present disclosure will be described on the basis of an embodiment with reference to the drawings. However, the present disclosure is not limited to the embodiment, and various numerical values and materials in the embodiment are examples. Note that the description will be made in the following order.

1. General description of projection-type display device and image display method of present disclosure

2. First embodiment (projection-type display device and image display method of present disclosure)

3. Other

### General Description of Projection-Type Display Device and Image Display Method of Present Disclosure

In the image display method of the present disclosure, the projection-type display device of the present disclosure is preferably used. That is, the image display method of the present disclosure using the projection-type display device of the present disclosure is an image display method using a projection-type display device including a light source, a light valve device, an illumination optical system that makes pieces of light in different colors from the light source respectively enter different regions of the light valve device, and a projection optical system that integrates images in different colors from the different regions of the light valve device into one image, the method including: generating a plurality of color-separated image signals by performing color separation of an image signal; forming images based on the color-separated image signals respectively in the plurality of regions of the light valve device by making the pieces of light in different colors from the light source respectively enter the different regions of the light valve device via the illumination optical system; and integrating the images formed in the plurality of regions of the light valve device into one image via the projection optical system. However, the image display method of the present disclosure is not limited to such a method of using the projection-type display device of the present disclosure.

In a projection-type display device of the present disclosure or a projection-type display device in an image display method using the projection-type display device of the present disclosure (hereinafter, these projection-type display devices will be collectively referred to as “projection-type display device of the present disclosure or the like”), different regions of a light valve device may include three regions, although not limited. Then, in this case, a red image, a green image, and a blue image may be respectively formed in the three different regions of the light valve device. Furthermore, a region other than the three different regions of the light valve device may perform displaying in black.

In addition, in these forms, the light valve device may have 4096×2160 pixels and each of the different regions of the light valve device may have 1920×1080 pixels. Also, in these forms including such a configuration, the light valve device may include a reflective liquid-crystal light valve device. Furthermore, in the projection-type display device of the present disclosure or the like including these forms and configurations, an illumination optical system may include one polarized beam splitter. Furthermore, in the projection-type display device of the present disclosure or the like including these forms and configurations, a projection optical system may include a prism combining optical system, specifically, one cross prism (more specifically, such as cross dichroic prism in which four triangular prisms are bonded and a bonded surface becomes a reflection dichroic mirror and which combines a plurality of optical paths into single optical path). If necessary, the projection optical system may further include a polarization converting optical system to adjust a polarization state of red, green, and blue light.

Furthermore, in the projection-type display device of the present disclosure or the like including the above-described preferable forms and configurations, an image control circuit that supplies an image signal to each of the different regions of the light valve device may be included.

In the projection-type display device of the present disclosure or the like, a light source may include three kinds of light emitting elements (such as semiconductor laser element or light emitting diode) that performs emission in red, green, and blue or may include a xenon lamp, a high-pressure mercury lamp (including extra high-pressure mercury lamp), a metal halide lamp, or a light emitting element (such as light emitting diode) that emits white light. In the latter case, by utilization of a color separation optical system (specifically, such as dichroic mirror formed by forming of dielectric multilayer film on glass plate) included in an illumination optical system, red, green, and blue are separated from light emitted from a xenon lamp, a high-pressure mercury lamp, a metal halide lamp, or a light emitting element that emits white light.

The illumination optical system includes one polarized beam splitter as described above and may additionally include, in some cases, an integrator such as a fly-eye integrator or a rod integrator, a polarization converting optical system, a polarization converting integrator optical system, a dichroic mirror, or various lens systems such as a condenser lens. Furthermore, a micro lens array may be included if necessary.

A light valve device also called a spatial light modulation device or a light valve is a device that controls an optical characteristic (such as light reflectance or light transmittance) at each spatial position in a two-dimensional plane. Writing of an input signal (image signal) into the light valve device can be performed, for example, on the basis of an electric address system. In a case where the light valve device includes a reflective liquid-crystal light valve device, the reflective liquid-crystal light valve device may specifically include liquid crystal on silicon (LCOS) or a high temperature polycrystalline silicon (HTPS)-TFT-driven reflective liquid crystal light valve device. However, the light valve device is not limited to this and may include a transmissive liquid-crystal light valve device (specifically, such as HTPS-TFT-driven transmissive liquid-crystal light valve device). Alternatively, the light valve device may include, for example, a digital micromirror to which MEMS technology is applied.

An image integrated (combined) into one by a projection optical system is projected onto a screen via a projection lens included in the projection optical system.

### First Embodiment

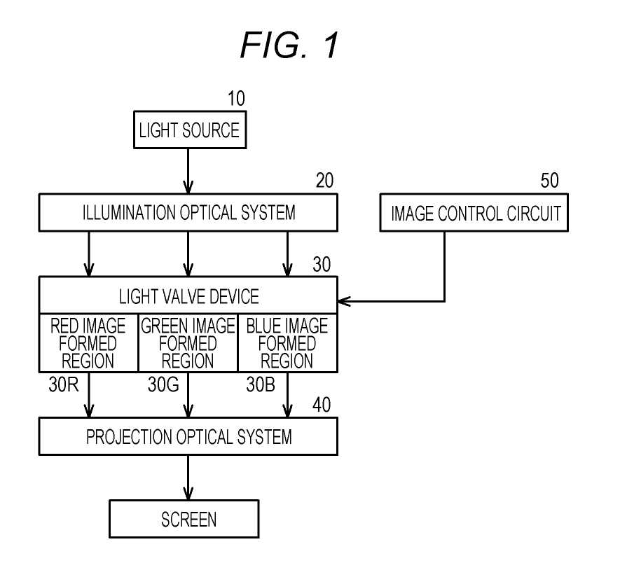

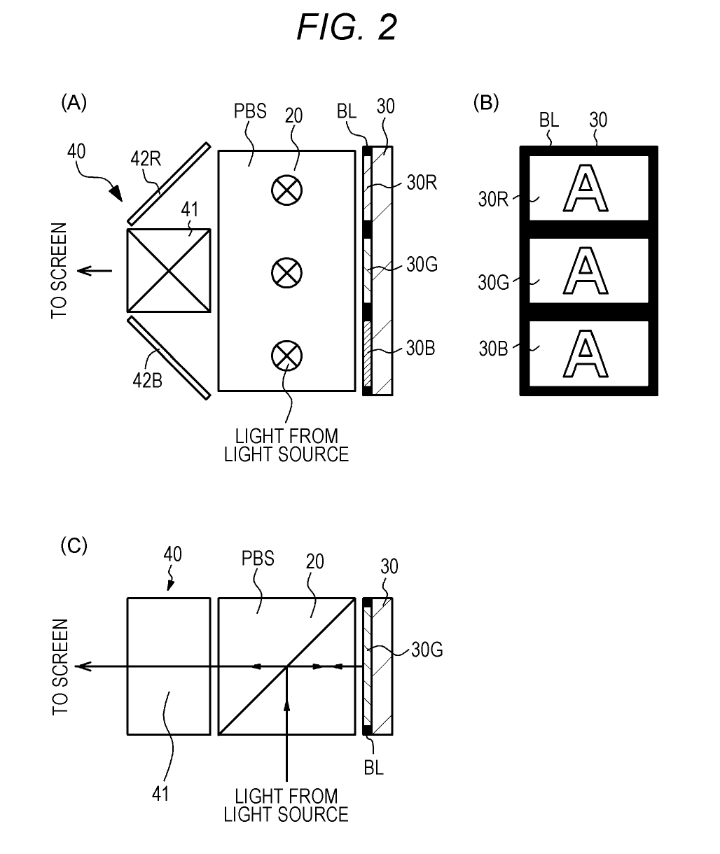

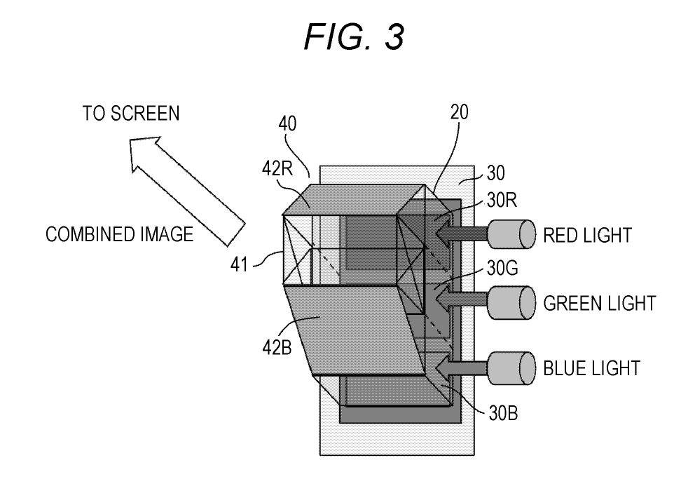

The first embodiment relates to a projection-type display device and an image display method of the present disclosure. A conceptual diagram of the projection-type display device of the first embodiment is illustrated in FIG. 1, a schematic side view of a main part of the projection-type display device is illustrated in (A) of FIG. 2, a schematic top view thereof is illustrated in (C) of FIG. 2, and a schematic front view of a light valve device is illustrated in (B) of FIG. 2. Also, a schematic perspective view is illustrated in FIG. 3.

The projection-type display device of the first embodiment includes

a light source 10,

a light valve device 30,

an illumination optical system 20 to make pieces of light in different colors from the light source 10 respectively enter different regions of the light valve device 30, and

a projection optical system 40 to integrate images in different colors from the different regions of the light valve device 30 into one image.

Here, the different regions of the light valve device 30 include three regions 30R, 30G, and 30B. Specifically, a red image, a green image, and a blue image are respectively formed in the three different regions 30R, 30G, and 30B of the light valve device 30. In (B) of FIG. 2, a state in which an image indicating a letter “A” is formed is illustrated. A region in which a red image is formed is referred to as a red image formed region 30R, a region in which a green image is formed is referred to as a green image formed region 30G, and a region in which a blue image is formed is referred to as a blue image formed region 30B. Images that are the same except for a point that colors and luminance are different from each other are formed in the red image formed region 30R, the green image formed region 30G, and the blue image formed region 30B. Also, a region other than the three different regions 30R, 30G, and 30B of the light valve device 30 performs displaying in black. This region displaying a black image (so-called black matrix region) is referred to as a region BM. The light valve device 30 includes a reflective liquid-crystal light valve device, more specifically, LCOS. Then, the light valve device 30 has 4096×2160 pixels and each of the different regions 30R, 30G, and 30B of the light valve device 30 has 1920×1080 pixels. That is, it becomes possible to display a full hi-vision image by using LCOS for so-called “4K” and it is possible to display an image with resolution equivalent to that of a conventional full high-vision three-panel projection-type display device.

The illumination optical system 20 includes one polarized beam splitter PBS. Also, the projection optical system 40 includes a prism combining optical system, specifically, one cross prism (more specifically, cross dichroic prism 41) and mirrors 42R and 42B. Note that a polarization converting optical system (specifically, ½ wavelength plate) to adjust a polarization state of red and blue light may be included on a light entering side or a light emitting side of the mirrors 42R and 42B if necessary.

The light source 10 includes three kinds of light emitting elements (such as light emitting diode) to perform emission in red, green, and blue although not limited. Also, an image integrated (combined) into one by the projection optical system 40 is projected onto a screen (not illustrated) via a projection lens (not illustrated) included in the projection optical system 40.

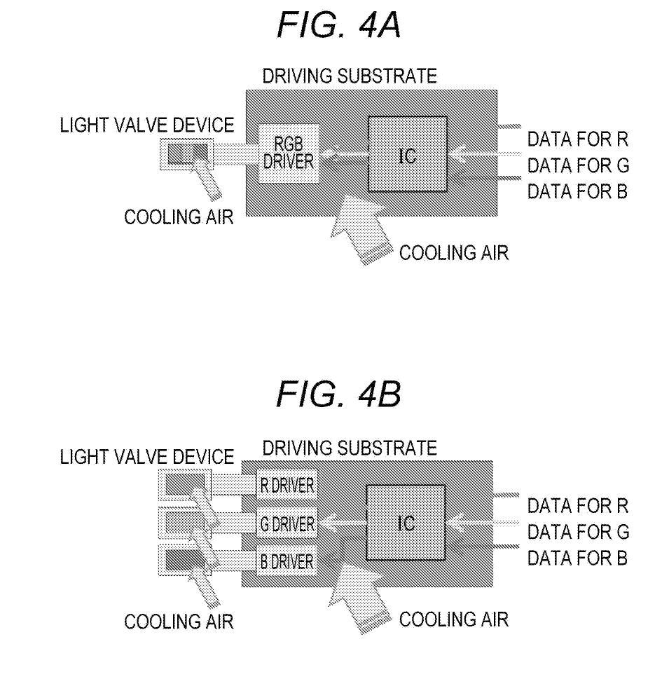

Also, as illustrated in a conceptual diagram in FIG. 4A, the projection-type display device of the first embodiment includes an image control circuit 50 that supplies an image signal to each of the different regions 30R, 30G, and 30B of the light valve device 30. Note that a conceptual diagram of an image control circuit in a conventional three-panel projection-type display device is illustrated in FIG. 4B.

In the projection-type display device of the first embodiment, light from the light source 10 enters one polarized beam splitter PBS included in the illumination optical system 20. In the polarized beam splitter PBS, p-polarized light passes through the polarized beam splitter PBS. On the other hand, s-polarized light is reflected by the polarized beam splitter PBS and travels to the light valve device 30. The light that collides with the light valve device 30 and is reflected by the light valve device 30 becomes p-polarized light. Depending on an optical path, the light is reflected on the mirrors 42R and 42B and travels to the cross dichroic prism 41 included in the projection optical system 40. Note that in a case where a polarization converting optical system (specifically, ½ wavelength plate) to adjust a polarization state of red and blue light is included, s-polarized red light and blue light travel to the cross dichroic prism 41. Then, red light (red image), green light (green image), and blue light (blue image) are combined by the cross dichroic prism 41 and are integrated into one image. The image integrated into one is projected on a screen (not illustrated) via a projection lens (not illustrated) included in the projection optical system 40.

That is, in the image control circuit 50, color separation of an image signal from the outside (see data for R, data for G, and data for B in FIG. 4) is performed by an integrated circuit IC and a plurality of color-separated image signals (image signal on which color separation is performed) is generated. The plurality of color-separated image signals is transmitted to an RGB driving driver. Drive signals to respectively drive a region in which a red image is formed (red image formed region) 30R, a region in which a green image is formed (green image formed region) 30G, and a region in which a blue image is formed (blue image formed region) 30B are generated on the basis of the color-separated image signals and are respectively transmitted to the regions 30R, 30G, and 30B. That is, processing of three color-separated image signals is performed in a band of one channel. In such a manner, while pieces of light in different colors from the light source 10 are respectively made to enter the different regions 30R, 30G, and 30B of the light valve device 30 via the illumination optical system 20, images based on color-separated image signals are respectively formed in the plurality of regions 30R, 30G, and 30B of the light valve device 30. Then, the images respectively formed in the plurality of regions 30R, 30G, and 30B of the light valve device 30 on the basis of the color-separated image signals are integrated into one image via the projection optical system 40 and are projected onto a screen (not illustrated) via a projection lens (not illustrated) included in the projection optical system 40.

Incidentally, as illustrated in FIG. 4B, in the conventional three-panel projection-type display device, three light valve devices and three driving drivers are necessary. Also, various optical members to cover a size of the light valve devices (various optical member included in illumination optical system or projection optical system) are necessary for each of the light valve devices. As a result, a production cost is increased, a size of the projection-type display device is increased, and power consumption is increased. Note that since it is difficult to downside a part and a member other than the light valve devices in order to keep a characteristic, it is difficult to downsize the whole projection-type display device. In addition, it is necessary to accurately align and assemble the three light valve devices and one cross dichroic prism. As a pixel size becomes smaller, an assembling cost is increased and assembling becomes more difficult. Moreover, since there are the three light valve devices and the three driving drivers, a cooling system becomes more complicated and larger, and power consumption is increased.

On the other hand, since it is only necessary for the projection-type display device of the first embodiment to include one light valve device 30 and one RGB driving driver, it is possible to reduce a production cost, to downsize an optical part and an optical member, to reduce the number of optical parts and optical members, to downsize a driving substrate, to downsize the whole projection-type display device, and to reduce power consumption. In addition, since it is only necessary to accurately align and assemble one light valve device and one cross dichroic prism, an assembling cost is not increased and assembling does not become more difficult even in a case where a pixel size becomes small. That is, when it is assumed that a horizontal direction of the light valve device is an X direction and a vertical direction thereof is a Y direction, positional misalignment with respect to a rotation around a Z axis does not become a problem. Also, positional misalignment in the X direction and the Y direction can be adjusted by performance of image signal processing (specifically, for example, by performance of image signal processing in such manner that image is moved in X direction or Y direction for intended number of pixel). In addition, since it is only necessary to include one light valve device and one driving driver, it is possible to reduce the amount of heat generation, to simplify and downsize a cooling system, and to reduce power consumption. That is, it is possible to reduce the number of cooling ducts, to reduce the number of cooling fans, and to reduce a quantity of airflow, for example. Moreover, quietness can be realized.

Also, in a liquid-crystal light valve device, a liquid-crystal orientation disorder region called disclination may be generated in a case where pixels with different luminance become adjacent to each other. A generated position of the orientation disorder region may vary depending on a layout of an optical member. In this case, coloring may be generated in the liquid-crystal orientation disorder region. Thus, in order to control coloring due to disclination, there is a case where it is necessary to manufacture two kinds of liquid-crystal light valve devices having different orientation directions of liquid crystal molecules. On the other hand, in the projection-type display device of first embodiment, a red image, a green image, and a blue image are formed by the one light valve device 30. Since it is possible to easily match parts, in which image quality is deteriorated, with a configuration such as the projection optical system 40, it is possible to control coloring.

As described above, in the projection-type display device of the first embodiment, one light valve device is divided into a plurality of regions, images in different colors are respectively formed in the divided regions, and the images in different colors are integrated into one image. Also, in an image display method of the present disclosure, images based on color-separated image signals acquired by color separation of an image signal are respectively formed in a plurality of regions of one light valve device and these images are integrated into one image. Thus, it is possible to avoid problems such as an increase in a size of the projection-type display device and an increase in power consumption, to reduce assembling processes, and to avoid an increase in a production cost with high assembling accuracy not being required much. Also, unlike the three-panel projection-type display device, it is not necessary to match three light valve devices and to consider a variation in a color temperature.

In the above, a projection-type display device and an image display method of the present disclosure have been described on the basis of a preferred embodiment. However, the projection-type display device and the image display method of the present disclosure are not limited to the embodiment. It is obvious that a configuration and a structure of the projection-type display device described in the embodiment can be arbitrarily modified.

Note that the present disclosure may include the following configuration.

[A01] <<Projection-Type Display Device>>

A projection-type display device including:

a light source;

a light valve device;

an illumination optical system that makes pieces of light in different colors from the light source respectively enter different regions of the light valve device; and

a projection optical system that integrates images in different colors from the different regions of the light valve device into one image.

[A02] The projection-type display device according to [A01], in which the different regions of the light valve device include three regions.

[A03] The projection-type display device according to [A02], in which a red image, a green image, and a blue image are respectively formed in the three different regions of the light valve device.

[A04] The projection-type display device according to [A03], in which a region other than the three different regions of the light valve device performs displaying in black.

[A05] The projection-type display device according to any one of [A02] to [A04], in which the light valve device has 4096×2160 pixels and each of the different regions of the light valve device has 1920×1080 pixels.

[A06] The projection-type display device according to any one of [A02] to [A05], in which the light valve device includes a reflective liquid-crystal light valve device.

[A07] The projection-type display device according to any one of [A01] to [A06], in which the illumination optical system includes one polarized beam splitter.

[A08] The projection-type display device according to any one of [A01] to [A07], in which the projection optical system includes one cross prism.

[A09] The projection-type display device according to any one of [A01] to [A08], further including an image control circuit to supply an image signal to each of the different regions of the light valve device.

[B01] <<Image Display Method>>

An image display method including:

generating a plurality of color-separated image signals by performing color separation of an image signal;

forming images based on the color-separated image signals respectively in a plurality of regions of a light valve device; and

integrating the images formed in the plurality of regions of the light valve device into one image.

[C01] <<Image Display Method>>

An image display method using a projection-type display device including

a light source,

a light valve device,

an illumination optical system to make pieces of light in different colors from the light source respectively enter different regions of the light valve device, and

a projection optical system to integrate images in different colors from the different regions of the light valve device into one image, the method including:

generating a plurality of color-separated image signals by performing color separation of an image signal;

forming images based on the color-separated image signals respectively in the plurality of regions of the light valve device by making the pieces of light in different colors from the light source respectively enter the different regions of the light valve device via the illumination optical system; and

integrating the images formed in the plurality of regions of the light valve device into one image via the projection optical system.

[C02] The image display method according to [C01], in which the different regions of the light valve device include three regions.

[C03] The image display method according to [C02], in which a red image, a green image, and a blue image are respectively formed in the three different regions of the light valve device.

[C04] The image display method according to [C03], in which a region other than the three different regions of the light valve device performs displaying in black.

[C05] The image display method according to any one of [C02] to [C04], in which the light valve device has 4096×2160 pixels, and each of the different regions of the light valve device has 1920×1080 pixels.

[C06] The image display method according to any one of [C02] to [C05], in which the light valve device includes a reflective liquid-crystal light valve device.

[C07] The image display method according to any one of [C01] to [C06], in which the illumination optical system includes one polarized beam splitter.

[C08] The image display method according to any one of [C01] to [C07], in which the projection optical system includes one cross prism.

[C09] The image display method according to any one of [C01] to [C08], further including an image control circuit to supply an image signal to each of the different regions of the light valve device.

### REFERENCE SIGNS LIST

10 Light source

20 Illumination optical system

PBS Polarized beam splitter

30 Light valve device

30R, 30G, 30B Different region of light valve device

BM Region displaying black image

40 Projection optical system

41 Cross dichroic prism

42R, 42B Mirror

50 Image control circuit

IC Integrated circuit

1. A projection-type display device comprising:
a light source;
a light valve device;
an illumination optical system that makes pieces of light in different colors from the light source respectively enter different regions of the light valve device; and
a projection optical system that integrates images in different colors from the different regions of the light valve device into one image.

2. The projection-type display device according to claim 1, wherein the different regions of the light valve device include three regions.

3. The projection-type display device according to claim 2, wherein a red image, a green image, and a blue image are respectively formed in the three different regions of the light valve device.

4. The projection-type display device according to claim 3, wherein a region other than the three different regions of the light valve device performs displaying in black.

5. The projection-type display device according to claim 2, wherein
the light valve device has 4096×2160 pixels, and
each of the different regions of the light valve device has 1920×1080 pixels.

6. The projection-type display device according to claim 2, wherein the light valve device includes a reflective liquid-crystal light valve device.

7. The projection-type display device according to claim 1, wherein the illumination optical system includes one polarized beam splitter.

8. The projection-type display device according to claim 1, wherein the projection optical system includes one cross prism.

9. The projection-type display device according to claim 1, further comprising an image control circuit to supply an image signal to each of the different regions of the light valve device.

10. An image display method comprising:
generating a plurality of color-separated image signals by performing color separation of an image signal;
forming images based on the color-separated image signals respectively in a plurality of regions of a light valve device; and
integrating the images formed in the plurality of regions of the light valve device into one image.
